(19) United States
(12) Patent Application Publication
(10) Pub. No.: US 2023/0292788 A1
(43) Pub. Date: Sep. 21, 2023

(54) PRODUCTION OF NON-PRECIPITATED PLANT PROTEIN ISOLATES

(71) Applicant: IMPROVE, Dury (FR)

(72) Inventor: Jérôme SCHWAB, NAMPS AU MONT (FR)

(21) Appl. No.: 18/012,886

(22) PCT Filed: Jun. 25, 2021
(86) PCT No.: PCT/EP2021/067468

§ 371 Date: Dec. 23, 2022

(30) Foreign Application Priority Data
Jun. 26, 2020 (EP) 20305715.3

(51) Int. Cl. A23J 1/00; A23J 1/14; A23J 1/12

(52) U.S. Cl. CPC A23J 1/006; A23J 1/14; A23J 1/12

(57) ABSTRACT

Disclosed is a method for preparing a protein isolate displaying a purity higher than 80% from plant parts, the method including the following successive steps: a) washing the plant parts in acidic conditions, thereby obtaining acid washed plant parts; b) contacting the acid washed plant parts with an alkaline solution; and c) recovering the liquid fraction thereby obtaining a protein isolate displaying a purity higher than 80%. The method does not include any acidic precipitation step.

### FIELD OF THE INVENTION

The present invention concerns the preparation of plant protein isolates.

### TECHNICAL BACKGROUND

Plant materials include a versatile wide and varied group of plant parts from versatile species. General categories of plant materials include grasses, woods, stems, roots, seeds, and leaves. Basic chemical composition is similar among the structures, as each one is made up with polysaccharides, proteins, lipids and other minor components. Instead, differences are to be found in proportions among these macro-components, the kinds of and their biological activity, such as structural (woods, stems, roots), respiratory (leaves) and energy reservoir (starch and proteins) of the plant (seeds). Therefore, proteins are integrated in complex and different architectures made up with several kinds of molecules.

Seed proteins were empirically classified by Osborne on the basis of their solubility, as follows:
water extractable (albumins);
extractable in diluted salt solutions (globulins);
extractable in aqueous alcohol (prolamins);
extractable by weakly acidic or alkaline or diluted SDS solutions (glutelins).

Later on, seed proteins have been also categorized based on their sedimentation coefficients (S) (Mandal and Mandal (2000) Current Science 79:576-589).

Classification divides seed proteins into storage, structural and biologically active proteins. As shown in Table 1 below, classification divides seed proteins into albumins (2S) which constitutes diverse biologically active proteins (lectins, enzymes and enzyme inhibitors) and storage proteins remobilized during seed germination. Globulins (7S whose molecular weight is comprised between 150 and 190 kDa and 11/12S whose molecular weight is comprised between 300 and 360 kDa) are the major storage proteins of dicots (e.g. pulses and oilseeds beans) whereas prolamin and glutelin families are major storage proteins in monocots (e.g. cereals).

Protein concentrates or isolates from seeds are interesting ingredients for the food industry, due to their nutritional values and functional abilities. Production processes are generally developed according to final product specifications. In fact, the value of a protein ingredient increases as a function of its purity and functionality. The market price for a non-soluble concentrate is low (<2 €/kg), whereas a soluble protein isolate able to foam, to stabilize an emulsion, or to get gel reaches high-end market prices between 4-8 €/kg.

TABLE 1
Seed proteins solubility (Osborne's classification)

| Proteins fraction | Albumin | Globulin | Prolamin | Glutelin |
|---|---|---|---|---|
| Solubility | Water | Salty solution | Ethanol 70% | pH > 11 |
| Function in plant | Physiologic | Storage | Storage | Storage |
| Soybean | 10% | 90% | | |
| Pea | 20% | 65% | | 15% |
| Faba bean | 25% | 55% | | 20% |
| Sunflower | 20% | 60% | 5% | 15% |
| Rapeseed | 50% | 25% | 5% | 10% |
| Mil | 8% | 4% | 46% | 42% |
| Wheat | 5% | 10% | 45% | 40% |

Wet fractionation process is a combination of unit operations having the purpose to exploit physicochemical properties of proteins, such as their solubility, in order to separate and to isolate them from other macro-components, as well as micro-components. Using this strategy, it is possible to produce protein isolates enriched in globulin-protein fraction with a high-purity level (>90% proteins, over dry matter—N×6,25).

The simplest wet fractionation process used to produce protein concentrates or isolates from pulse seeds or oilseed cake consists in a two-step process described in U.S. Pat. No. 2,785,155. In this process, the raw matter is suspended in an alkaline environment permitting protein extraction (globulin and albumin families, mainly) and solubilizing said proteins in the solvent, leaving other insoluble components (starch and fibers) dispersed in the same solvent.

Following solid/liquid separation cleaning the supernatant, protein purification is performed by isoelectric precipitation. Addition of acid chemical, like hydrochloric acid, is managed to reach the pH at which electrical charges are neutralized (usually, pH range 4.0-5.0). Reduced interactions between proteins and solvent allows them to change the phase (solution/suspension) and to precipitate. Then, solid/liquid separation enables collecting precipitated proteins, which can be optionally neutralized and dried at the end of the process.

Later, the process was optimized and other versions or ways to produce protein isolates were proposed, such as performing the extraction step in acidic conditions (Alli et al. (1993) J. Agr. Food Chem. 41:1830-1834), or in water (Klamczynska et al. (2001) Int. J Food Sci. & Technol. 36:563-572). Observing overall purity of obtained products, acid and/or alkaline extraction shows high purity level (>90 %), while 50-65 % is purity level of water extracted proteins (Chéreau et aL (2016) OCL 23: D406.

Alternatively, ultrafiltration way can be used to purify protein instead of acid precipitation (Olsen et al. (1978) J. Sci. Food Agric. 29:323-331). The main difference with isoelectric precipitation is that protein physicochemical properties, like solubility and technological abilities, are generally of higher level when using ultrafiltration approach.

Classically, purification process steps are designed to maximize yield and purity of final isolate. Extraction and solubilization are usually implemented in alkaline environment, because the extraction yield is higher and interactions between phytic acid and proteins are reduced (Ghodsvali et al. (2005) Food Res. Int 38:223-231).

However, extreme alkaline conditions (pH>11) have drawbacks because they can lead to protein denaturation, reducing protein solubility and related techno-functional properties (Ma et al. (1990) J. Agric. Food Chem. 38:1707-1711; Manamperi et aL (2011) J. Food Sci. 76: E266-E273). Also, digestibility can be impacted by these conditions, due to loss of amino acid residues, like lysine, cysteine, serine, threonine, arginine, and some other amino acids residues. In fact, alkali-treated proteins can contain some unusual compounds, such as ornithine, β-aminoalanine, lysinoalanine, ornithinoalanine, lanthionine, methyllanthionine and D-allo-isoleucine, as well as other D-amino acids (Deng et aL (1990) Can. Inst. Food Sci. Technol. J. 23:140-142).

Furthermore, in these oxidative media, chemical irreversible reactions between proteins and polyphenols are favored. High temperature, metals and oxygen presence are pro-oxidative factors as well, leading to dark-colored final protein isolate, which is unwanted by the food industry and the consumer (Wanasundara (2011) Crit. Rev. Food Sci. Nutr. 51:635-677; Sȩczyk et aL (2019) Molecules 24:408.

To improve flavor of protein isolates, several strategies have been studied. The use of additives added to alkaline medium to counter the oxidative environment is one of them. For example, some kinds of antioxidant-action additives can be used at this stage, like polyacids, sodium hexametaphosphate (SHMP), sodium sulfite, or sodium bisulfite. The use of additives typically limits oxidation phenomena of proteins and polyphenols as well as their interactions. However, addition of chemicals has a cost, that will increase final isolate price. Furthermore, the use of these molecules can be regulated and limited by Country regulations.

Alternatively, off-flavors precursors can be removed by washing raw matter before extraction and solubilization step.

Alcohol-washing is typically used as solvent to clean up flour and defatted cakes because of its ability to remove soluble material as simple sugars, oligosaccharides, fat, and ash from the sample as well as other minor components like volatiles, as they are soluble in alcohol. Typically, such a solvent can remove beany, green flavor from soybeans, peanuts and groundnuts. The use of an amphiphilic, organic and food-grade solvent can thus be a plus to pre-wash raw matter, enabling removing small amounts of lipids as well as off-flavors precursors, such as phenolic compounds. However, interaction between the solvent used for pre-washing and proteins can have negative consequences on protein 3D, denaturing its structure, thereby reducing its technical functionalities (Roland et al. (2017) Cereal Chem. J. 94:58-65. Furthermore, the use of ethanol can have an impact from a technical point of view and costs. Indeed, it is well known that ethanol is flammable and explosive. Accordingly, explosive atmosphere zones (ATEX) environment and machines/equipment, which are more expensive in term of total cost of ownership and purchasing price, are necessary to treat alcohol-prewashed flour and cakes. Furthermore, such process implies additional processes of desolventizing raw matter and of purifying ethanol, in order to recycle it.

There is thus an important need for new methods for preparing plant protein isolates with a high purity, while limiting the presence of off-flavors, improving odor, color and functional properties, removing anti-nutritional factors and/or avoiding expensive equipment.

### SUMMARY OF THE INVENTION

The present invention arises from the unexpected finding by the inventors that, it is possible, by performing an acid wash on the plant material to remove anti-nutritional factors and off-flavors and directly isolate proteins by alkaline extraction, without applying a precipitation step, in particular an acidic precipitation step. Such a method improves the quality of the final isolate because it can remove off-flavors, reduce undesired and typical plant odors, and increase neutral color of the final isolate. The nutritional quality is also increased by removing α-galactosides, which are anti-nutritional factors. Moreover, avoiding implementation of a precipitation step, in particular an acidic precipitation, enables maintaining the protein structures, thereby obtaining a high-quality protein isolate. The protein isolate obtained by said method also advantageously has improved functional properties, such as an improved solubility, an improved gelling property, an improved foaming capacity and a low viscosity.

The protein isolate can thus be used in food compositions, as a protein source improving digestive comfort, in particular by comparison to a protein isolate obtained by conventional methods, and/or for its functional properties.

A first object of the invention is thus a protein isolate from plant parts, in particular a legume protein isolate, wherein said protein isolate comprises at least 80% of proteins on dry matter and comprises less than 0,10% of alpha-galactosides by weight of the protein isolate.

Another object of the invention is a composition comprising at least one protein isolate as defined above, in particular a food composition, a feed composition, a pet-food composition, a cosmetic composition, a nutraceutical composition or a pharmaceutical composition.

Another object of the invention is a method for preparing a protein isolate as defined above, said method comprising the following successive steps:
a) washing said plant parts in acidic conditions, thereby obtaining acid washed plant parts;
b) contacting said acid washed plant parts with an alkaline solution, and
c) recovering the liquid fraction, thereby obtaining a protein isolate displaying a purity higher than 80%.

Said method preferably does not comprise any acidic precipitation step.

The present invention thus particularly concerns a method for preparing a protein isolate displaying a purity of at least 80%, preferably equal to or higher than 85% from plant parts, said method comprising the following successive steps:
a) washing said plant parts in acidic conditions, thereby obtaining acid washed plant parts;
b) contacting said acid washed plant parts with an alkaline solution, and
c) recovering the liquid fraction thereby obtaining a protein isolate displaying a purity of at least 80%, preferably equal to or higher than 85%, wherein said method does not comprise any precipitation step and any membrane filtration step.

Another object of the invention is the use of a protein isolate as defined above as a nutritional ingredient, in particular for improving digestive comfort, and/or as a functional ingredient, for example as a foaming agent and/or as a gelling agent, in particular in a composition as defined above.

### DETAILED DESCRIPTION OF THE INVENTION

### Plants and Plant Parts

By “plant” is meant herein all plants and plant populations such as desirable and undesirable wild plants, cultivars and plant varieties (whether or not protectable by plant variety or plant breeder's rights). Examples of plants which can be used in the context of the invention include legumes, pulses, oil seed plants, cereals, root plants and micro-algae.

By “pulse”, it is herein meant the edible seed from a legume plant.

Pulses include for example lupine, mung bean, bambara groundnut, yellow pea, soy, faba bean, chickpea, lentils, beans and pongamia.

Oil seeds plants include for example canola, rapeseed, sunflower and camellia.

Cereals include for example corn, oat and barley.

Root plants include for example potato and casava.

In a preferred embodiment, the plant as defined above is not an oil seed plant.

In a particular embodiment, said plants are legumes.

By “legume” is meant herein plants of the Fabaceae or Leguminosae family, which include the six following subfamilies: Cercidoideae (including the Bauhinia and Cercis genera), Detarioideae (including the Amherstia, Detarium and Tamarindus genera), Duparquetioideae (including the Duparquetia genera), Dialioideae (including the Dialium genera), Caesalpinioideae (including the Caesalpinia, Senna, Mimosa and Acacia genera), and Faboideae (including the Astragalus, Lupinus and Pisum genera).

In a particular embodiment, said plants are of the Faboideae subfamily, more particularly of the Cicer, Glycine, Lathyrus, Lens, Lupinus, Medicago, Phaseolus, Pisum, Trifolium, Vicia, or Vigna genera.

In still a particular embodiment, said plants are peas, faba beans, chick peas or soybeans.

In a preferred embodiment, the plant as defined above is not soybean or more preferably, is not a Glycine max.

In a preferred embodiment, the plant as defined above is a legume, said legume being not a soybean or more preferably being not a Glycine max.

In one embodiment, the plant as defined above, preferably a legume, is not a plant of the genus Glycine.

By “plant parts” is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners and seeds also belong to plant parts.

In the context of the invention, plant parts also encompass by-products of the plant food industry.

In a particular embodiment, said plant parts are seeds.

In a particular embodiment, said plant parts are used, in the washing step a), under a mechanically transformed form, such as for example flour or dehulled seeds.

In a particular embodiment, said plant parts, in particular said seeds, are used in the form of flour, of dehulled seeds or of cakes, in the washing step a) of the method of the invention.

However, since one of the main advantages of the method of the invention is to avoid protein precipitation during extraction, the plant parts used during the washing step a) of the method of the invention, have preferably not be submitted to a prior protein extraction.

### Protein Isolate

The present invention particularly relates to a protein isolate.

By “protein isolate” is usually meant a product which contains at least 85 % of proteins on dry matter. Typically, a protein isolate corresponds to the most refined form of protein products containing the greatest concentration of proteins but containing no dietary fibre. By extension, a “protein isolate” as defined herein comprises at least 80% of proteins on dry matter.

The protein isolate of the invention may thus comprises at least 80% of proteins on dry matter, which means that the protein isolate displays a purity of at least 80% on dry matter.

By “purity”, is meant herein the ratio of the weight of proteins in the isolate to the total weight of the isolate on dry matter.

The protein isolate is preferably obtained by the method as defined above or below in the section “Method for preparing a protein isolate”.

The method of the invention thus enables preparing a protein isolate displaying a purity of at least 80%, preferably equal or higher than 85%.

The protein isolate of the invention is preferably in the form of a powder.

In a preferred embodiment, the protein isolate is a legume protein isolate, said legume being preferably not a soybean, more preferably being not a Glycine max.

The protein isolate as defined above is preferably obtained from dehulled seeds or flour.

The protein isolate of the invention is preferably further characterized by at least one feature, preferably at least two features, more preferably at least three, four, five, six or seven features, selected from the group consisting of an improved colour, an improved taste, an improved odour, an improved solubility, a gelling property, an improved foaming capacity, a low viscosity and a reduced amount of α-galactosides, in particular by comparison to a protein isolate obtained by a method comprising a first step of alkaline extraction followed by a second step of acidic precipitation, also referred herein as a “standard pH-metric process”, and, preferably, by comparison to commercial protein isolates.

The protein isolate as defined above preferably has a reduced amount of α-galactosides and is preferably further characterized by at least one feature, preferably at least two features, more preferably at least three, four, five or six features, selected from the group consisting of an improved colour, an improved taste, an improved odour, an improved solubility, a gelling property, an improved foaming capacity and a low viscosity, in particular by comparison to a protein isolate obtained by a method comprising a first step of alkaline extraction followed by a second step of acidic precipitation, also referred herein as a “standard pH-metric process”, and, preferably, by comparison to commercial protein isolates.

A standard pH-metric process for example comprises a first step of alkaline extraction at pH 9, for example at 55° C. for 30 minutes, and a second step of acidic precipitation at pH 4,5, for example at 55° C. for 15 minutes.

A standard pH-metric process may particularly comprise:
a first step of alkaline extraction at pH 9, preferably at 55° C., preferably with NaOH, preferably during 30 minutes, followed by one or two solid/liquid separations, to obtain a supernatant,
a second step of acidic precipitation of the obtained supernatant at pH 4,5, preferably at 55° C., preferably with sulphuric acid, preferably during 15 minutes, to obtain a precipitate,
optionally, a step of washing the obtained precipitate, preferably with water at pH 4,5, followed by a solid/liquid separation,
optionally, a neutralization step, at a pH from 6,8 to 7 with NaOH,
optionally, a step of heat treatment, for example at 90° C. for 90 seconds, and
optionally, a step of drying, preferably in a spray dryer.

A standard pH-metric process is illustrated in example 5.

The standard pH-metric process does not comprise additional steps, in particular aiming at improving the organoleptic, functional and/or nutritional properties of the protein isolate.

Colour, taste and odour particularly define the organoleptic quality of the protein isolate.

By “protein isolate having an improved colour”, it is herein meant that the protein isolate provided in the form of a powder has a less yellow aspect (i.e. a lower b* value) and, preferably, is significantly lighter (i.e. a higher L* value), in particular by comparison to a protein isolate powder obtained by a standard pH-metric process.

The protein isolate of the invention preferably has a b value lower than 15, preferably lower than 14, more preferably lower than 13. On the contrary, a protein isolate obtained by a standard pH-metric process or known commercial protein isolates have a b* value greater than 20, sometimes even greater than 30.

The colour may be assessed by any method well known by the skilled person. For example, the color may be assessed with a colorimeter according to the method L*a*b as disclosed in Table 14.

Since the granulometry of a powder may impact the L* value, the colour comparison between two powders has to be performed on powders having a similar granulometry.

By “protein isolate having an improved odour”, it is herein meant a protein isolate have a neutral odour without beany smell, in particular by comparison to a protein isolate powder obtained by a standard pH-metric process.

The odour may be assessed by any method well known by the skilled person. For example, a sensory panel may be used on the protein isolate in dry or liquid form.

By “protein isolate having an improved taste”, it is herein meant a protein isolate having a more neutral taste and/or a better perception in mouth, in particular by comparison to a protein isolate obtained by a standard pH-metric process.

The legume protein isolate of the inventions advantageously has nut, cereal and/or milk notes, whereas commercial references or a protein isolate obtained by a standard pH-metric process has pea or beany aftertaste.

The taste may be assessed by any method well known by the skilled person. For example, a sensory panel may be used on the protein isolate in dry or liquid form.

Solubility, gelling properties, foaming capacity and low viscosity particularly define the functional properties of the protein isolate.

By “a protein isolate having an improved solubility”, it is herein meant that the solubility of the protein isolate as defined above is higher than those of a protein isolate obtained by a standard pH-metric process.

The solubility of the isolate protein of the invention in a 2% proteins solution, is preferably at least 30% and at least 10 % higher at pH 6 and 8 respectively, than those of a protein isolate obtained by a standard pH-metric process.

The solubility may be assessed by any method well known by the skilled person. For example, the preparation of a 2% protein solution at the targeted pH and the protein content estimation by Kjeldahl method on the supernatant after centrifugation (15000 g, 10 min).

By the expression “x % protein solution”, it is herein meant a solution comprising x g of protein for 100 ml of solution.

The solubility of a protein isolate of the invention is preferably of higher than 50% at pH 8, more preferably higher than 60% at pH 8, more preferably higher than 70% at pH 8.

By “protein isolate having a gelling property”, it is herein meant that the proteins of the protein isolate have the capacity of forming a gel by heating of a 10% protein solution, in particular contrary to a protein isolate obtained by a standard pH-metric process.

The gelling property may be assessed by any method well known by the skilled person. For example, a 10% protein solution at pH 7 is subjected to a temperature ramp from 25° C. to 90° C. with a gradient of 2° C./min. The viscosity measurement is done with a DHR-2-rheometer (TA) with a 40 mm plate/plate geometry.

By “protein isolate having an improved foaming capacity”, it is herein meant that the foam volume of a 0.1% protein solution of said protein isolate is at least 1,1 times higher after 20 s and/or at least 15 times higher after 600 s than a protein solution of a protein isolate obtained by a standard pH-metric process.

The foaming capacity may be assessed by any method well known by the skilled person. For example, the foam volume and stability of a 0.1% protein solution at pH 7 is measured with a FOAMSCAN™ device.

By “protein isolate having a low viscosity”, it is herein meant that the viscosity of a 10% protein solution of said protein isolate is below 0.1 Pa/s at a 100 s⁻¹ shear rate, preferably below 0.05 Pa/s.

The viscosity of a 10% protein solution of the protein isolate is advantageously 4 times lower, preferably 5 times lower, than an equivalent solution of a protein isolate obtained by a standard pH-metric process at the same shear rate, for example at 100 s⁻¹ shear rate.

Viscosity may be assessed by any method well known by the skilled person. For example, viscosity is measured with a DHR-2-rheometer (TA) with a 40 mm plate/plate geometry.

A reduced amount of α-galactosides, which are anti-nutritional factors, particularly defines the nutritional quality of the protein isolate.

A reduced amount of α-galactosides particularly allows improving digestive comfort.

Alpha-galactosides are indeed undigestible sugars which can cause flatulences and digestive issues. They are present in seeds such as peas, lentils and beans.

By “α-galactoside”, it is herein meant a glycoside containing a galactose, which is characterized by the presence of an a linkage. The main α-galactosides found in legume seeds are raffinose, stachyose and verbascose.

By “amount of α-galactosides”, it is thus herein meant the amount of raffinose, stachyose and verbascose.

α-galactosides constitute about 5 to 18% of the dry weight of mature legume seeds.

For illustration purposes, the average alpha-galactosides content is 5 g/100 g in pea flour and 10 g/100 g in pea concentrate (IMPROVE data).

The protein isolate of the invention preferably comprises less than 0,10% of α-galactosides by weight of the protein isolate.

On the contrary, a protein isolate obtained by a standard pH-metric process comprises more than 1,7% of α-galactosides by weight of the protein isolate.

The protein isolate as defined above is preferably characterized in that it comprises less than 0,10% of α-galactosides by weight of the protein isolate and has at least one feature, preferably at least two features, more preferably at least three, at least four, at least five, at least six or seven features, selected from the group consisting of:
a less yellow color, by comparison to a protein isolate obtained by a method comprising a first step of alkaline extraction followed by a second step of acid precipitation,
an improved taste by comparison to a protein isolate obtained by a method comprising a first step of alkaline extraction followed by a second step of acid precipitation,
a neutral odor without beany smell,
a solubility higher than 50% at pH8 in a 2% protein solution,
an improved foaming capacity, by comparison to a protein isolate obtained by a method comprising a first step of alkaline extraction followed by a second step of acid precipitation,
a gelling property, and
a low viscosity.

A preferred protein isolate as defined above is characterized in that said protein isolate:
comprises at least 80% of proteins on dry matter,
comprises less than 0,10% of α-galactosides by weight of the protein isolate,
has (i) a less yellow color, by comparison to a protein isolate obtained by a method comprising a first step of alkaline extraction followed by a second step of acid precipitation, and/or (ii) a solubility higher than 50% at pH8 in a 2% protein solution, and
optionally, has (i) an improved taste by comparison to a protein isolate obtained by a method comprising a first step of alkaline extraction followed by a second step of acid precipitation and/or (ii) a neutral odor without beany smell.

A preferred protein isolate as defined above is more particularly characterized in that said protein isolate:
comprises at least 80% of proteins on dry matter,
comprises less than 0,10% of α-galactosides by weight of the protein isolate,
has (i) a b value lower than 15, preferably lower than 14, more preferably lower than 13 and/or (ii) a solubility higher than 50% at pH8 in a 2% protein solution, and
optionally, has (i) a taste characterized by nut, cereal and/or milk notes and/or (ii) a neutral odor without beany smell.

A legume protein isolate as defined above, in particular a pea protein isolate or a faba bean protein isolate of the invention, is particularly characterized by an improved colour, an improved taste, an improved odour, an improved solubility, a gelling property, an improved foaming capacity, a low viscosity and a reduced amount of α-galactosides, in particular by comparison a protein isolate obtained by a method comprising an alkaline extraction step followed by an acidic precipitation step.

### Composition Comprising a Protein Isolate

The present invention also relates to a composition comprising at least one protein isolate as defined above.

The composition as defined above may comprise from 0,01% to 99% of protein isolate, the percentage being expressed by weight of the composition.

The composition as defined above may for example comprise from 0,01% to 5% of protein isolate, preferably from 0.1% to 5% of protein isolate, more preferably from 1% to 5% of protein isolate, the percentage being expressed by weight of the composition, in particular when the protein isolate is used as a functional agent.

Alternatively, the composition as defined above may comprise from 5% to 90 % of the protein isolate, preferably from 5% to 80% of the protein isolate, more preferably from 5% to 70% of the protein isolate, more preferably from 5% to 60% of the protein isolate, still more preferably from 5% to 50% of the protein isolate, for example from 5% to 40% of the protein isolate or from 5% to 30% of the protein isolate, the percentage being expressed by weight of the composition, in particular when the protein isolate is used as a nutritional agent.

If at least two protein isolates as defined above are used in the composition, they preferably originate from different genus and/or species of legume.

If at least two protein isolates as defined above are used in the composition, the above percentages correspond to the total weight of the proteins isolates of the invention.

The composition as defined above is preferably a food composition, a feed composition (such as but not limited to aquafeed), a pet-food composition, a cosmetic composition, a nutraceutical composition or a pharmaceutical composition.

The food composition, in particular for human consumption, may for example comprise or consist of a meat substitute or analogue, a dairy substitute or analogue, a snack, a cereal product, or a functional product suitable for sport nutrition. The food composition may for example comprise or consist of a plant-based yoghurt, plant based beverage or high protein snack.

### Use of a Protein Isolate

Because of its nutritional quality and functional properties, in particular its gelling property and its foaming capacity, the protein isolate as defined above may be used as nutritional ingredient, in particular for improving digestive comfort and/or as a functional ingredient, for example as a foaming agent and/or as a gelling agent.

The present invention thus also relates to the use of a protein isolate as defined above as a nutritional ingredient, for example for improving digestive comfort, and/or as a functional ingredient, for example as a foaming agent and/or as a gelling agent, in particular in a composition as defined above.

### Method for Preparing a Protein Isolate

The present invention thus relates to a method for preparing a protein isolate, in particular as defined above, said method comprising the following successive steps:
a) washing said plant parts in acidic conditions, thereby obtaining acid washed plant parts,
a′) optionally, rinsing said acid washed plant parts with an aqueous solution,
b) contacting said acid washed plant parts obtained in step a) or a′) with an alkaline solution, and
c) recovering the liquid fraction thereby obtaining a protein isolate displaying a purity of at least 80%, preferably equal or higher than 85%.

The method as defined above preferably does not comprise any acidic precipitation, preferably any precipitation step, in particular to obtain the protein isolate displaying a purity of at least 80%, preferably equal or higher than 85% at step c).

The method as defined above preferably does not comprise any precipitation step.

The method as defined above preferably does not comprise any membrane filtration step

The method as defined above preferably does not comprise any step of removing fat of the plant parts.

The method as defined above advantageously enables starch and fibers fractionation process, without starch denaturation.

The washing step a), the rinsing step a)′ and the extraction step (comprising steps b) and c)) are particularly as defined below.

In a preferred embodiment, the protein isolate is a legume, said legume being preferably not a soybean, more preferably being not a Glycine max.

### Washing Step

Step a) of the method of the invention consists in washing the plant parts, as defined in section “Plants and plant parts” above, in acidic conditions, thereby obtaining acid washed plant parts.

The plant parts are preferably provided in the form of dehulled seeds or flour.

The flour may be characterized in that 90% of the grains have a particle size of less than 300 μm (also referred to as D90-300 μm) or less than 200 μm (also referred to as D90-200 μm).

The plant part is preferably not a defatted plant part.

By “acidic conditions” is meant herein that the washing solution with which said plant parts are washed has a pH of less than 7. Preferably, the pH of said washing step is comprised between 3.5 and 5, more particularly between 4 and 4.5.

Said washing solution may typically be acidified water. Said acidified water may be obtained using weak acid, such as citric acid, or using strong acid, such as sulfuric acid.

Said washing may be implemented by any technique well-known from the skilled person. Typically, said plant parts may be mixed with said acidified water and incubated for 5 min to 30 min, in particular for 10 min to 20 min.

In a particular embodiment, said washing step is performed under agitation.

In still a particular embodiment, said washing step is performed at a temperature comprised between 10° C. and 60° C., more particularly between 12° C. and 55° C., still particularly between 20° C. and 50° C. In a particular embodiment, said washing step is performed at a temperature comprised between 10° C. and 20° C., more particularly between 12° C. and 15° C. In an alternative embodiment, said washing step is performed at a temperature comprised between 50° C. and 60° C., more particularly between 50° C. and 55° C.

In a preferred embodiment, the washing step is performed at a temperature comprised from 52° C. to 58° C., for example around 55° C.

In a particular embodiment, said acid washed plant parts are recovered at the end of said washing step by solid/liquid separation.

Solid-liquid separation techniques are well-known from the skilled person and include floatation, sedimentation, centrifugation, cake filtration, screening and attachments. In a particular embodiment, said solid/liquid separation is performed by centrifugation.

As will be understood by the skilled person, proteins of interest included in the plants parts washed at step a) of the method of the invention, are not soluble at an acidic pH. On the contrary, molecules responsible of potential off-flavors, as well as the albumin fraction of said plant parts, are typically soluble in such conditions.

Unexpectedly, alpha-glucosides are also solubilized during step a).

Accordingly, proteins of interest are typically recovered in the solid phase after the solid/liquid separation, whereas molecules responsible of potential off-flavors, α-galactosides, yellow coloration and albumin are typically discarded through the liquid phase after the solid/liquid separation.

In a particular embodiment, said acid washed plant parts recovered at the end of said washing step have a pH comprised between 3.5 and 5, more particularly between 4 and 4.5.

In a particular embodiment, said washing step may be repeated. However, preferably said washing step is performed only once.

### Rinsing Step

In a particular embodiment, the method of the invention further comprises between the washing step a) and the contacting step b), a step of rinsing said acid washed plant parts with an aqueous solution.

The rinsing step allows increasing purity of the protein isolate.

Said aqueous solution is preferably water, in particular ultra-pure water.

Said rinsing may be implemented by any technique well-known from the skilled person. Typically, said acid washed plant parts may be mixed with said aqueous solution and incubated for 5 min to 30 min, in particular for 10 min to 20 min.

In a particular embodiment, said rinsing step is performed under agitation.

In still a particular embodiment, said rinsing step is performed at a temperature comprised between 10° C. and 60° C., more particularly between 12° C. and 55° C., still particularly between 20° C. and 50° C. In a particular embodiment, said rinsing step is performed at a temperature comprised between 10° C. and 20° C., more particularly between 12° C. and 15° C. In an alternative embodiment, said rinsing step is performed at a temperature comprised between 50° C. and 60° C., more particularly between 50° C. and 55° C.

In a preferred embodiment, the rinsing step is performed at a temperature comprised from 52° C. to 58° C., for example around 55° C.

In a particular embodiment, said rinsed acid washed plant parts are recovered at the end of said rinsing step by solid/liquid separation.

Solid-liquid separation techniques are well-known from the skilled person and include floatation, sedimentation, centrifugation, cake filtration, screening and attachments. In a particular embodiment, said solid/liquid separation is performed by centrifugation.

In a particular embodiment, said rinsed acid washed plant parts recovered at the end of said rinsing step have a pH comprised between 3.5 and 5, more particularly between 3.5 and 4.

In a particular embodiment, said rinsing step may be repeated. Preferably, said rinsing step is performed twice.

### Extraction Step

Step b) of the method of the invention consists in contacting the acid washed plant parts (or rinsed acid washed plant parts when a rinsing step in performed) with an alkaline solution.

By “alkaline solution” is meant herein a solution with a pH higher than 7, preferably a pH higher than 8, more preferably a pH of 9.

In a particular embodiment, said acid washed plant parts are mixed with an aqueous solution, such as water, and the pH of said mixture is then adjusted to an alkaline pH, in particular to a pH higher than 7, preferably a pH higher than 8, more preferably a pH of 9.

In an alternative embodiment, said acid washed plant parts are mixed an alkaline solution which has a pH of 7 to 9, in particular a pH of 7, 8 or 9.

Said contacting step may be implemented by any technique well-known from the skilled person. Typically, said acid washed plant parts may be mixed with said solution and incubated for 5 min to 30 min, in particular for 10 min to 20 min.

In a particular embodiment, said contacting step is performed under agitation.

Preferably, said acid washed plant parts are not in the form of a suspension during said contacting step.

In still a particular embodiment, said contacting step is performed at a temperature comprised between 10° C. and 60° C., more particularly between 12° C. and 55° C., still particularly between 20° C. and 50° C. In a particular embodiment, said contacting step is performed at a temperature comprised between 10° C. and 20° C., more particularly between 12° C. and 15° C. In an alternative embodiment, said contacting step is performed at a temperature comprised between 50° C. and 60° C., more particularly between 50° C. and 55° C.

Step c) of the method of the invention consists in recovering the liquid fraction which corresponds to the protein isolate prepared by the method of the invention.

Indeed, proteins of interest are typically soluble at alkaline pH, which enables separating them from other constituents of plant parts typically insoluble at such pH, such as the prolamin and glutelin fractions.

In a particular embodiment, said recovering step is performed at a temperature comprised between 10° C. and 60° C., more particularly between 12° C. and 55° C., still particularly between 20° C. and 50° C. In a particular embodiment, said recovering step is performed at a temperature comprised between 10° C. and 30° C., preferably between 10° C. and 20° C., more particularly between 12° C. and 15° C. In an alternative embodiment, said recovering step is performed at a temperature comprised between 50° C. and 60° C., more particularly between 50° C. and 55° C.

The extraction step, i.e. both steps b) and c), is advantageously performed at a temperature lower than or equal to 30° C. A temperature greater than 30° C. can indeed result in starch degradation as well as in an alteration of the protein isolate quality.

In a particular embodiment, said liquid fraction is recovered at the end of said recovering step by solid/liquid separation.

Solid-liquid separation techniques are well-known from the skilled person and include floatation, sedimentation, centrifugation, cake filtration, screening and attachments. In a particular embodiment, said solid/liquid separation is performed by centrifugation.

The present inventors demonstrated that about 65% of the proteins present in plant parts were extracted using the method of the invention, which is a yield similar to the yield of the prior art extraction methods. Furthermore, the method of the invention enables obtaining protein isolates with a purity higher than 80%, preferably higher than 85%, both at the lab scale and semi-industrial scale.

However, the method of the invention does not need any precipitation step, in particular any acidic precipitation step, and any membrane filtration step for obtaining protein isolate displaying such a purity level. Accordingly, in the context of the invention, protein isolates are typically directly obtained at said recovering step c). As will be understood by the skilled person, the fact of not applying any precipitation step enables avoiding denaturing extracted proteins present in the isolates, which thus improves the quality of the protein isolates.

By “precipitation step” is meant herein a step aiming at precipitating proteins present in the sample. Such a precipitation step is well-known from the skilled person and typically includes acidic precipitation, organic solvent precipitation, thermal precipitation, ionic force precipitation and their combinations, such as an acidic and thermal precipitation. An acidic precipitation step is typically carried out at the isoelectric pH of the globulins, for example at a pH lower than or equal to 6, such as a pH lower than or equal to 5 or 4, preferably using hydrochloric acid (HCl).

By “membrane filtration step” is meant herein a step aiming at separating proteins from a liquid sample. Such a membrane filtration step is well-known from the skilled person and includes microfiltration, nanofiltration, ultrafiltration, reverse osmosis, membrane chromatography, high performance tangential flow filtration and electrophoretic membrane contactor.

As will be understood by the skilled person, no precipitation step (in particular no acidic precipitation step) or membrane filtration step is applied to obtain the protein isolate displaying a purity higher than 80%, preferably higher than 85% by the method of the invention. However, if the skilled person wishes to further purify the proteins of said isolate, or to further extract specific proteins of said isolate, such precipitation step and/or membrane filtration step may be applied on the protein isolate obtained by the method of the invention.

The method of the invention may further be used for sequential extraction of proteins, typically at different pH.

In that particular embodiment, said extraction steps b) and c) are repeated at least once, at a higher pH.

Such a repetition enables sequentially extracting different proteins which are soluble at different alkaline pH.

For example, said extraction step b) may further be performed at a pH of 7, and then repeated, after said recovering step c), at a pH of 8, and for example repeated once again at a pH of 9.

The method as defined above for preparing a protein isolate may for example comprise the following successive steps:
a) washing said plant parts in acidic conditions, thereby obtaining acid washed plant parts,
a′) optionally, rinsing said acid washed plant parts with an aqueous solution, for example once or twice,
b) contacting said acid washed plant parts obtained in step a) or a′) with an alkaline solution at a first pH,
c) recovering the liquid fraction,
b′) contacting said liquid fraction obtained in step c) with an alkaline solution at a second pH,
c′) recovering the liquid fraction,
b″) contacting said liquid fraction obtained in step c′) with an alkaline solution at a third pH1, and
c″) recovering the liquid fraction,
   thereby obtaining a protein isolate displaying a purity higher than 80%,
   wherein the first pH is lower than or equal to the second pH and the second pH is lower than or equal to the third pH, and
   wherein the method preferably does not comprise any acidic precipitation step, preferably any precipitation step, and, optionally, does not comprises any membrane filtration step.

For example, in the method as defined above, the first pH is 7, the second pH is 8 and the third pH is 9.

### Additional Steps

The method of the invention may further comprise, after said recovering step c) optional additional steps, typically additional steps useful to stabilize, preserve, concentrate or package said protein isolates.

In a particular embodiment, the method of the invention further comprises after said recovering step c) a neutralization step, a heat treatment step, a concentration step and/or a drying step.

Neutralization steps are well-known from the skilled person and typically involves adjusting pH of the protein isolates to a value of about 7.

Heat treatment steps are well-known from the skilled person, and aim at stabilizing the protein isolates. For example, heat treatment may be performed in a tubular heat exchanger for example at a temperature higher than 70° C., for example at 90° C., for a small period, for example for 30 s to 2 min, typically for 90 s.

Concentration step may be performed by any technique well-known from the skilled person, such as by evaporation.

Drying step may be performed by any technique well-known from the skilled person, such as by spray drying.

The present invention will be further illustrated by the figures and examples below.

### BRIEF DESCRIPTION OF THE FIGURES

FIG. 1: Pilot scale process description

FIG. 2: Evaluation of the foaming capacity

FIG. 3: Proteins solubility

FIG. 4: Gelling property of standard pH-metric proteins

FIG. 5: Gelling property of proteins obtained by the method of the invention

FIG. 6: Viscosity of proteins solution (10% DS)

FIG. 7: Viscosity evolution according to the DS content

### EXAMPLES

### Example 1: Process Development on Faba Bean

The aim of these pre-series of tests was to define the main steps of the proteins' extraction and purification process. There were performed with dehulled faba bean flour, at lab scale.

Materials and methods are described in Table 2.

TABLE 2
Materials and methods

| Step | Principle | Material and method |
|---|---|---|
| Acid wash 1 | Flour and acidified water | Flour: Pin milled, dehulled faba bean |
| | mixing followed by a solid/ | Acidified ultra-pure water with citric acid. |
| | liquid separation | Citric acid powder quantity = 3% of flour |
| | | quantity |
| | | Flour on acidified water ratio: ⅙ |
| | | Q citric acid + Q water + Q flour = Q_{AW1} |
| | | Temperature: 50° C. |
| | | pH target, after flour addition: 4.5 |
| | | Time before solid/liquid separation: 10 min |
| | | Agitation: magnetic stirrer |
| Acid wash 2 | Pellets of acid wash 1 | Acidified RO water with citric acid. |
| | and acidified water | Citric acid/water ratio: Equivalent to acid |
| | mixing, followed by a | wash 1 |
| | solid/liquid separation | Acidified water addition: qs Q_{AW1} |
| | | Temperature: 50° C. |
| | | pH, after pellets addition: 3.6 |
| | | Time before solid/liquid separation: 10 min |
| | | Agitation: magnetic stirrer |
| Rinse step | Pellets of acid wash and | Ultra-pure water addition: qs Q_{AW1} |
| | water mixing, followed by | Temperature: 50° C. |
| | a solid/liquid separation | pH, after pellets addition: 3.5 |
| | | Time before solid/liquid separation: 10 min |
| | | Agitation: magnetic stirrer |
| Extraction | Pellets of the rinse step | Ultra-pure water: qs Q_{AW1} |
| | and water mixing at | Temperature: 50° C. |
| | alkaline pH, followed by a | pH adjustment, after pellets addition: 9 |
| | solid/liquid separation | Time before solid/liquid separation: 10 min |
| | | Agitation: magnetic stirrer |
| Pellets | Pellets of extraction and | Ultra-pure water: qs Q_{AW1} |
| rewash | water mixing, followed by | Temperature: 50° C. |
| | a solid/liquid separation | pH, after pellets addition: 9 |
| | | Time before solid/liquid separation: 10 min |
| | | Agitation: magnetic stirrer |

| | |
|---|---|
| Solid liquid separation | Lab centrifuge: Jouan KR 41 |
| | 4000 g during 10 min |
| Proteins analyses | Nitrogen analysis by Kjeldhal (Foss ®) |
| | following the ISO method 5983-2. The |
| | proteins (Pt) content is the nitrogen content |
| | multiplied by 6.25. |
| Dry solid and ash analyses | Prepash system (Precisa ®) |

### Results and Discussion

As shown in Table 3, the combination of an acid wash followed by an alkaline extraction allowed the production of a proteins concentrate. The purity of the extract is higher than 80% of proteins on dry basis, without precipitation.

A second test was performed to decrease the proteins losses during the washing step and to increase the final extract purity.

Analytical results and mass balance are presented in Table 3. The final purity of the extract was over 85 %, without precipitation. Furthermore, the proteins extraction yield was comparable to a standard pH-metric process:

17% of the feed proteins were recovered in the wash and rinse supernatants. This fraction corresponds to the albumin fraction, which is recovered in the precipitate supernatant in a standard pH-metric process.

11% of the feed proteins stayed insoluble after extraction. It corresponds to the prolamine and glutelin fractions, which are also not recovered with a standard pH-metric process.

65% of the proteins were extracted under alkaline conditions. This yield is comparable to the pH metric process.

### Conclusion

The process of the invention allows the production of a non-precipitated proteins isolate. The extraction yield is not affected compared to prior art pH-metric processes.

TABLE 3
Mass balance and analytical results

| | | Globulins | | Insoluble |
|---|---|---|---|---|
| | Protein purity | recovery yield | Albumins | proteins |
| | of alkaline | (alkaline | recovery yield | recovery |
| Example | extract | extract) | (acid extract) | yield |
| 1 | 81% | 46% | 36% | 12% |
| 2 | 85% | 65% | 17% | 11% |

### Example 2: Process Improvement on Faba Bean

The aim of these series of tests was to optimize the process by decreasing the amount of inputs (acid). There were performed with dehulled faba bean flour, at lab scale. Materials and methods are described in Table 4.

TABLE 4
Materials and methods

| Step | Principle | Material and method |
|---|---|---|
| Acid wash | Flour and acidified | Flour: Roll milled D90 = 300 μm and |
| Option 1: | water mixing followed | D50 = 100 μm, dehulled faba bean |
| weak acid | by a solid/liquid | Acidified ultra-pure water with citric acid + |
| and base | separation | sodium citrate |
| combination | | Citric acid powder quantity = 3% of flour |
| | | quantity |
| | | Flour on acidified water ratio: ⅙ |
| | | Q citric acid + Q water + Q flour = Q_{AW1} |
| | | Temperature: 50° C. |
| | | pH target, after flour addition: 4.5 |
| | | Time before solid/liquid separation: 10 min |
| | | Agitation: magnetic stirrer |
| Acid wash | Flour and acidified | Flour: Roll milled, dehulled faba bean |
| Option 2: | water mixing followed | Acidified RO water with sulfuric acid |
| strong acid | by a solid/liquid | Sulfuric acid DS quantity = 1% of flour quantity |
| | separation | Flour on acidified water ratio: ⅙ |
| | | Q citric acid + Q water + Q flour = Q_{AW1} |
| | | Temperature: 50° C. |
| | | pH target, after flour addition: 4.5 |
| | | Time before solid/liquid separation: 10 min |
| | | Agitation: magnetic stirrer |
| Rinse step 1 | Pellets of acid wash and | Ultra-pure water: qs Q_{AW1} |
| | water mixing, followed | Temperature: 50° C. |
| | by a solid/liquid | pH, after pellets addition: 3.5 |
| | separation | Time before solid/liquid separation: 10 min |
| | | Agitation: magnetic stirrer |
| Rinse step 2 | Pellets of acid wash and | Ultra-pure water: qs Q_{AW1} |
| | water mixing, followed | Temperature: 50° C. |
| | by a solid/liquid | pH, after pellets addition: 3.5 |
| | separation | Time before solid/liquid separation: 10 min |
| | | Agitation: magnetic stirrer |
| Extraction | Pellets of the rinse step | Ultra-pure water: qs Q_{AW1} |
| | and water mixing at | Temperature: 50° C. |
| | alkaline pH, followed by | pH adjustment, after pellets addition: 7 |
| | a solid/liquid | Time before solid/liquid separation: 10 min |
| | separation | Agitation: magnetic stirrer |
| Pellets | Pellets of the rinse step | Ultra-pure water: qs Q_{AW1} |
| rewash | and water mixing at | Temperature: 50° C. |
| | alkaline pH, followed by | pH adjustment, after pellets addition: 9 |
| | a solid/liquid | Time before solid/liquid separation: 10 min |
| | separation | Agitation: magnetic stirrer |

| Solid liquid separation | Lab centrifuge: Jouan KR 41 |
|---|---|
| | 4000 g during 10 min |
| Proteins analyses | Nitrogen analysis by Kjeldhal (Foss ®) |
| | following the ISO method 5983-2. The proteins |
| | (Pt) content is the nitrogen content multiplied |
| | by 6.25. |
| Dry solid and ash analyses | Prepash system (Precisa ®) |

### Results and Discussion

As shown in Table 5, there was no significant difference in proteins extraction yield and purity, whatever the citric acid and sodium citrate ratio. Furthermore, the buffer effect was not improved by the sodium citrate addition.

TABLE 5
pH, weak acid and base effect on the
extract proteins purity and yield

| Test | A | B | C |
|---|---|---|---|
| Citric acid/flour content | 3.0% | 3.6% | 5.5% |
| Citrate Na/flour content | 0.0% | 2.0% | 6.0% |
| Wash pH | 4.45 | 4.57 | 4.57 |
| Rinse 1 pH | 4.52 | 4.75 | 4.73 |
| Rinse 2 pH | 4.6 | 4.86 | 4.83 |
| Albumin fraction yield | 16% | 16% | 18% |
| Glutelin fraction yield | 16% | 18% | 16% |
| Globulin fraction yield | 68% | 65% | 66% |
| Proteins purity, pH 7 | 97% | 98% | 97% |
| Estimated proteins purity, pH 9 | 91% | 93% | 92% |

According to these results, the right purity and extraction yield could be achieved as long as the pH was maintained between 4.45 and 4.86.

The quantity of acid related to the feed flour was however quite high.

A second set of tests was performed with strong acid to decrease the inputs consumption.

As presented in Table 6, the extract purity was not affected by the use of sulfuric acid. On another hand the inputs consumption was significantly reduced.

The buffer effect was not affected by the use of strong acid. The pH could be maintained between 4.6 and 4.7 during the rinse steps.

TABLE 6
Process validation with a strong acid

| Test | D | E |
|---|---|---|
| Sulfuric acid/flour content | 1.1% | 1.0% |
| Wash pH | 4.58 | 4.55 |
| Rinse 1 pH | 4.63 | 4.6 |
| Rinse 2 pH | 4.67 | 4.59 |
| Albumin fraction yield | 20% | 16% |
| Glutelin fraction yield | 17% | 18% |
| Globulin fraction yield | 63% | 63% |
| Proteins purity, pH 7 | 99% | 96% |
| Estimated proteins purity, pH 9 | 94% | 94% |

### Conclusion

The process comprising an acidic pre-wash followed by an alkaline extraction could be applied using strong acid, such as sulfuric acid, without affecting the protein extract purity.

The buffer effect of the acidified pellets was high enough to maintain a low pH during the rinse steps. The use of strong acid allowed a significant reduction of the inputs' consumption.

### Example 3: Sequential Extraction

The method of the invention could be used as a basis of a proteins range development. The acidic washing can be followed by a sequential extraction at different pH to perform proteins cracking.

Materials and methods for the prewashing and the solid/liquid separation is presented Table 4.

Extraction steps and the fat analysis were performed as described in Table 7.

TABLE 7
Materials and methods

| Step | Principle | Material and method |
|---|---|---|
| Extraction 1 | Pellets of the rinse step | Ultra-pure water: qs Q_{AW1} |
| | and water mixing at neutral | Temperature: 50° C. |
| | pH, followed by a solid/ | pH adjustment, after pellets addition: 7 |
| | liquid separation | Time before solid/liquid separation: 10 min |
| | | Agitation: magnetic stirrer |
| Extraction 2 | Pellets of the rinse step | Ultra-pure water: qs Q_{AW1} |
| | and water mixing at | Temperature: 50° C. |
| | alkaline pH, followed by a | pH adjustment, after pellets addition: 8 |
| | solid/liquid separation | Time before solid/liquid separation: 10 min |
| | | Agitation: magnetic stirrer |
| Extraction 3 | Pellets of the rinse step | Ultra-pure water: qs Q_{AW1} |
| | and water mixing at | Temperature: 50° C. |
| | alkaline pH, followed by a | pH adjustment, after pellets addition: 9 |
| | solid/liquid separation | Time before solid/liquid separation: 10 min |
| | | Agitation: magnetic stirrer |

| Fat content | NF ISO 11085, B process. Fat content |
|---|---|
| | measurement after an acidic hydrolysis. |

### Results

As shown in Table 8, extractions at pH 7 and pH 9 allowed the production of proteins isolate. At pH 8 the proteins purity was lower than 85 %. More than 68 % of the globulin fraction was extracted at pH 7.

TABLE 8
Mass balance, sequential extraction

| | | Globulins | | Insoluble |
|---|---|---|---|---|
| | Protein purity | recovery yield | Albumins | proteins |
| Extraction | of alkaline | (alkaline | recovery yield | recovery |
| pH | extract | extract) | (acid extract) | yield |
| 7 | 96% | 66% | 16% | 19% |
| 8 | 82% | | | |
| 9 | 100% | | | |

A second test was performed wherein the extraction at pH 7 was directly followed by an extraction at pH 9.

Results are summarized in Table 9. Again, the main fraction of globulins was extracted at pH 7. The proteins purity was also higher at this pH. Furthermore, the fat content was significantly higher after an extraction at pH 9.

TABLE 9
Proteins purity and fat content of proteins
fraction, according to the extraction pH

| Extraction condition | pH 7 | pH 9 |
|---|---|---|
| Proteins purity | 98% | 80% |
| Total proteins yield | 50% | 15% |
| Globulin yield | 77% | 23% |
| Fat content | 1.2% | 11.2% |

Conclusion:

The process comprising an acidic pre-washing followed by an alkaline extraction allowed a sequential extraction at different alkaline pH.

The proteins fraction composition varied according to the extraction pH.

Furthermore, it seemed that fat could be segregated in one specific proteins fraction. One can also expect different functionalities as the proteins fractions are not soluble at same pH. For example, the fraction, extracted at pH 7 can be used as soluble or instant proteins in beverage applications.

### Example 4: Application to Pea Proteins

The method of the invention was applied on yellow pea seeds. Material and method are described in Table 5. The seeds are thus proved in the form of a flour D90=300 μm and D50=100 μm.

The alkaline extract purity was higher than 85 % of proteins on dry matter and the globulins recovery yield was 68 %, which is in line with the faba bean results.

The method of the invention is thus suitable to pea proteins production.

### Example 5: Comparison of the Pea Proteins Quality

Two tests were performed at pilot scale to compare a conventional pH metric process with the method of the invention.

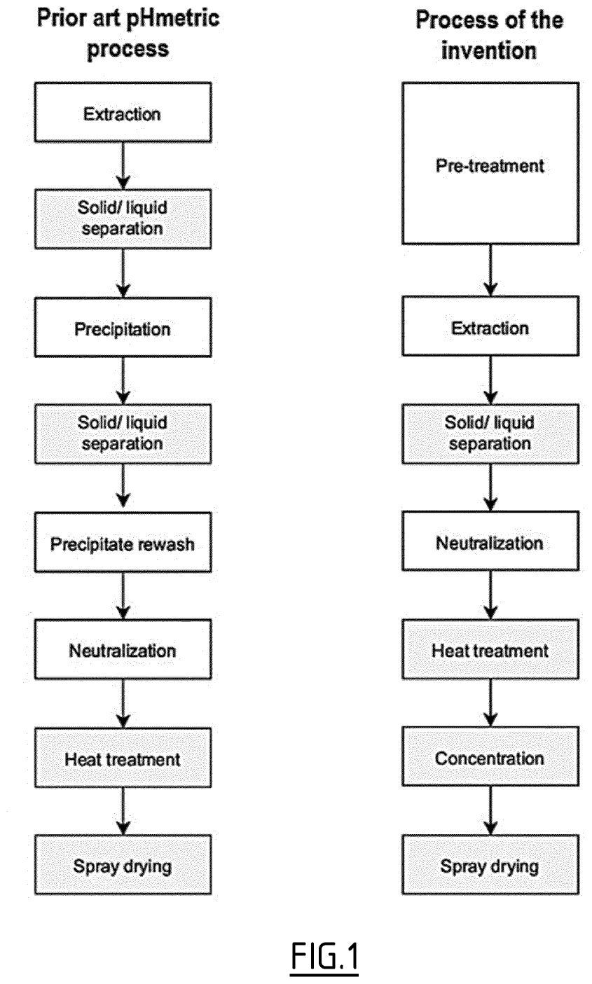

Both process diagrams are presented in FIG. 1.

Applied parameters and analytical methods are summarized in Tables 10, 11 and 12.

TABLE 10
Materials and methods for the standard pH-metric process

| Step | Principle | Material and method |
|---|---|---|
| Extraction | Alkaline extraction of | Reverse osmosis water |
| | flour proteins in a double | Temperature: 55° C. |
| | jacketed tank | pH adjustment, after pellets addition: 9, with |
| | | NaOH |
| | | Time before solid/liquid separation: 30 min |
| | | Agitation: 3 blades agitator, 150 rpm |
| Solid/liquid | Separation step after | Decanter Z23, Flottweg |
| separation 1 | extraction, precipitation | Temperature: 55° C. |
| | and precipitate rewash | Centrifugal force: 3500 to 4000 g |
| | | Differential speed: 5 to 20% |
| | | Impeller: 135 to 140 mm |
| | | Feed flow rate: 400 kg/h |
| Solid/liquid | Only used to clarify the | Disc stack centrifuge, Easy-Scale GEA |
| separation 2 | decanter supernatant | Temperature: 55° C. |
| | after extraction | Centrifugal force: 12 000 g |
| | | Total disludge/Partial disludge: ⅕ |
| | | Feed flow rate: 250 kg/h |
| Precipitation | Acidic proteins | Temperature: 55° C. |
| | precipitation of the | pH: 4.5 with Sulfuric acid |
| | extract supernatant | Time: 15 min |
| Precipitate | Precipitate rewash in RO | Reverse osmosis water |
| rewash | water at pH 4.5, followed | Precipitate/water ratio: ½ |
| | by a solid/liquid | |
| | separation | |
| Neutralization | Precipitate neutralization | pH: 6.8-7 with NaOH addition |
| | and dilution | RO water addition to decrease the viscosity |
| Heat | Product stabilization | Tubular heat exchanger, Actini |
| treatment | | Temperature: 90° C. |
| | | Holding time: 90 s |
| Drying | Product stabilization | Spray dryer |
| | | Inlet air temperature: 185° C. |
| | | Outlet air temperature: 85° C. |

TABLE 11
Materials and methods for the method of the invention

| Step | Principle | Material and method |
|---|---|---|
| Acid wash | Flour and acidified water | Reverse osmosis water |
| | mixing followed by a solid/ | Temperature: 55° C. |
| | liquid separation | pH target: 4 to 4.5 with sulfuric acid |
| | | Time before solid/liquid separation: 20 min |
| | | Agitation: 3 blades agitator, 150 rpm |
| Solid/liquid | Separation step after | Decanter Z23, Flottweg |
| separation 1 | acid wash, rinse and | Temperature: 55° C. |
| | extraction | Centrifugal force: 3500 to 4000 g |
| | | Differential speed: 5 to 20% |
| | | Impeller: 135 to 140 mm |
| | | Feed flow rate: 400 kg/h |
| Rinse 1 | Pellets of acid wash and | Reverse osmosis water, qs: Q_{AW} |
| | water mixing, followed by | Temperature: 55° C. |
| | a solid/liquid separation | 3 blades agitator, 150 rpm |
| | | Time: 10 min |
| Rinse 2 | Pellets of rinse 1 and | Reverse osmosis water, qs: Q_{AW} |
| | water mixing, followed by | Temperature: 55° C. |
| | a solid/liquid separation | 3 blades agitator, 150 rpm |
| | | Time: 10 min |
| Extraction | Alkaline extraction of | Reverse osmosis water |
| | rinsed pellets proteins in | Temperature: 55° C. |
| | a double jacketed tank | pH adjustment, after pellets addition: 9, with |
| | | NaOH |
| | | Time before solid/liquid separation: 30 min |
| | | Agitation: 3 blades agitator, 150 rpm |
| Solid/liquid | Only used to clarify the | Disc stack centrifuge, Easy-Scale GEA |
| separation 2 | decanter supernatant | Temperature: 55° C. |
| | after extraction | Centrifugal force: 12 000 g |
| | | Total disludge/Partial disludge: ⅕ |
| | | Feed flow rate: 250 kg/h |
| Neutralization | Extract neutralization | pH: 6.8-7 with NaOH addition |
| Heat | Product stabilization | Tubular heat exchanger, Actini |
| treatment | | Temperature: 90° C. |
| | | Holding time: 90 s |
| Concentration | Dry solid increase before | Falling film evaporator, GEA |
| | spray drying | Boiling temperature <50° C. |
| | | Concentration target for a viscosity <100 cp |
| Drying | Product stabilization | Spray dryer |
| | | Inlet air temperature: 185° C. |
| | | Outlet air temperature: 85° C. |

TABLE 12
Analytical methods for proteins characterization

| Analyses | Principle |
|---|---|
| Color | Evaluation with a colorimeter. Results are expressed by 3 parameters L*, a* |
| | and b *: |
| | L * (clarity), which ranges from 0 (black) to 100 (white) |
| | a * which ranges from −300 (green) axis to 299 (red). |
| | b * which ranges from −300 (blue) axis to 299 (yellow). |
| Foaming | Foaming properties were evaluated with a Foamscan (Teclis Scientific) using |
| properties | a 0.1% protein solution. Foam was formed by bubbling air in the solution at a |
| | flow rate of 200 ml/min for 30 seconds. The foam volume and its stability was |
| | then recorded during 600 seconds. Egg white is used as a reference for this |
| | test. |
| Solubility | The protein solubility was tested on protein suspensions at 2% protein |
| | content at different pH. The protein solubility was estimated by Kjeldahl |
| | method on the supernatant after centrifugation (15000 g, 10 min). |
| Gelling | Gelling capacity was measured on a DHR-2 rheometer (TA) with a 40 mm |
| properties | plate/plate geometry. A 10% protein solution at pH 7 was used. A |
| | temperature ramp was applied to the sample: heating from 25 to 90° C. with a |
| | gradient of 2° C./min, stabilization without oscillation at 90° C. for 10 minutes, |
| | cooling from 90 to 25° C. with a gradient of 2.5° C./min. A strain of 0.1% was |
| | applied during the test. G′ (storage modulus) and G″ (loss modulus) were |
| | measured |
| Viscosity | Rheological analysis was performed at 25° C. on a DHR-2 rheometer (TA) with |
| | a vane cup geometry. Different product concentrations were used. Viscosity |
| | profile was measured on a shear rate range between 0.1 s⁻¹ and 1 000 s⁻¹. |

### Results:

As shown in Table 13, there is a significant difference of color between both powders.

TABLE 13
Lab measurement results

| Data | L | a | b |
|---|---|---|---|
| Standard | 89.74 | −0.78 | 20.51 |
| Invention | 89.79 | 1.09 | 12.81 |

Each product was tasted as such and in 4% solution by 6 different people (naïve panel). The beany intensity of proteins obtained by the method of the invention was evaluated as significantly lower than standard pH-metric proteins.

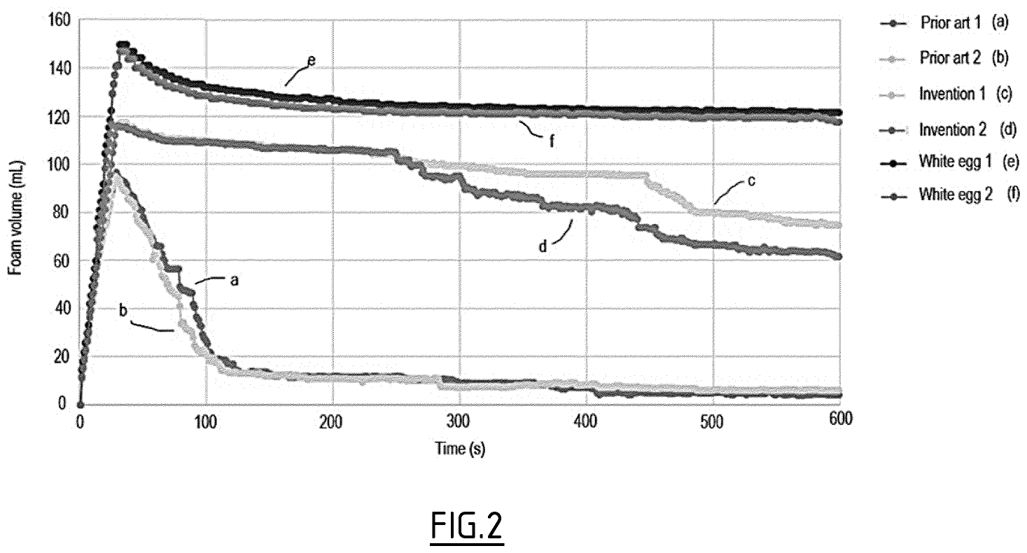

As shown in FIG. 2, the proteins obtained by the method of the invention have a higher foaming capacity than precipitated proteins and the foam is stable over time.

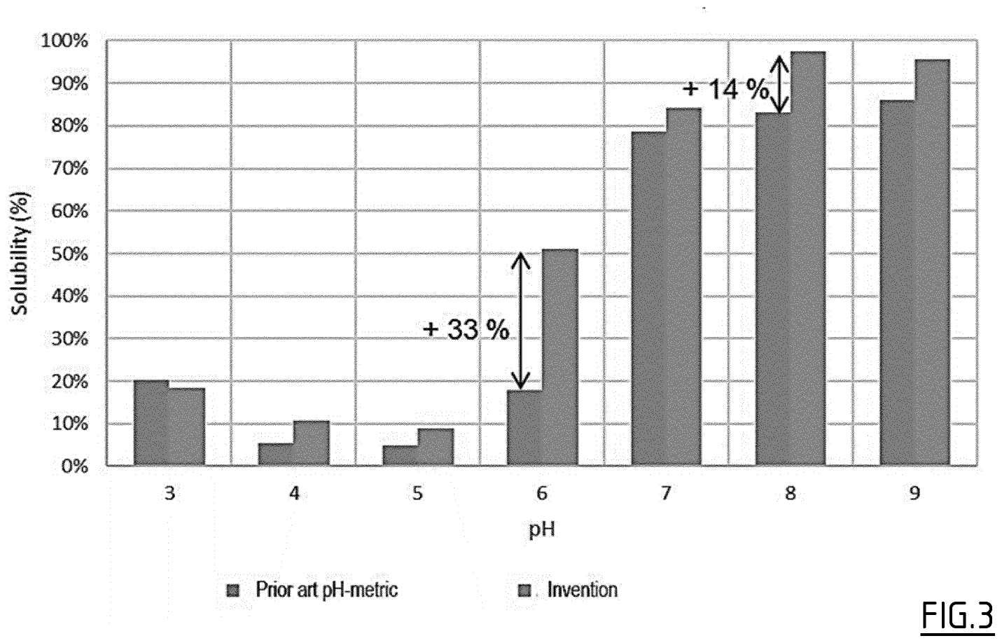

The proteins solubility was also significantly improved by the method of the invention, as shown in FIG. 3 and in the Table 14 below.

Table 14 shows the solubility of a protein isolate of the invention versus commercial-type products.

Protein solubility was evaluated by solubilizing the sample in water at different pH and measuring the proportion of proteins in the supernatant after centrifugation. Samples of the protein isolate of the invention (hereinafter defined as Batch 1 and Batch 2) show much higher solubility at pH 3,7 and 8 than commercial isolate samples (hereinafter defined as Commercial 1 and Commercial 2).

TABLE 14
Solubility of the samples at different pH

| Products | pH 3 | pH 4 | pH 5 | pH 6 | pH 7 | pH 8 |
|---|---|---|---|---|---|---|
| Batch 1 | 31 | 7 | 7 | 41 | 65 | 79 |
| Batch 2 | 58 | 7 | 8 | 11 | 70 | 80 |
| Commercial 1 | 12 | 6 | 6 | 11 | 18 | 22 |
| Commercial 2 | 16 | 5 | 6 | 14 | 23 | 29 |

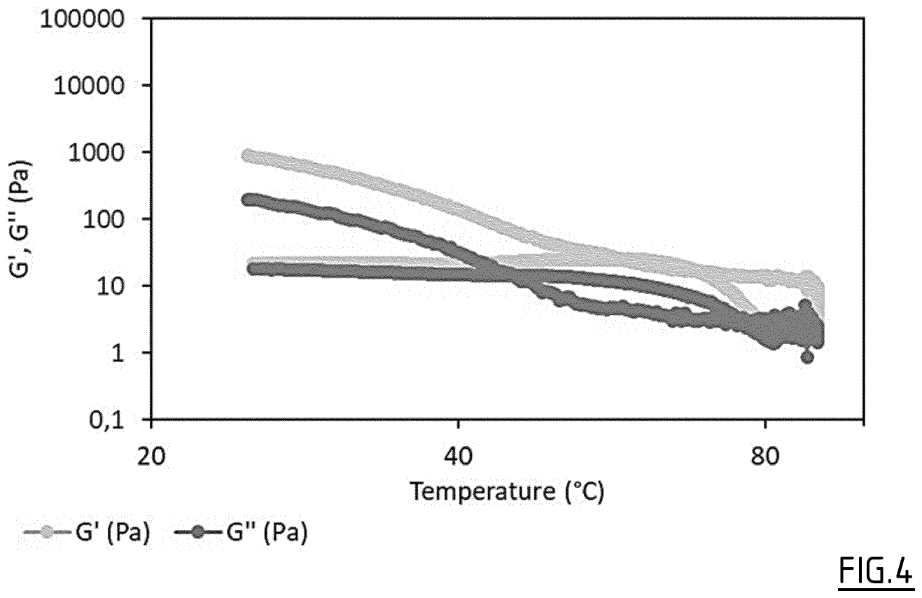

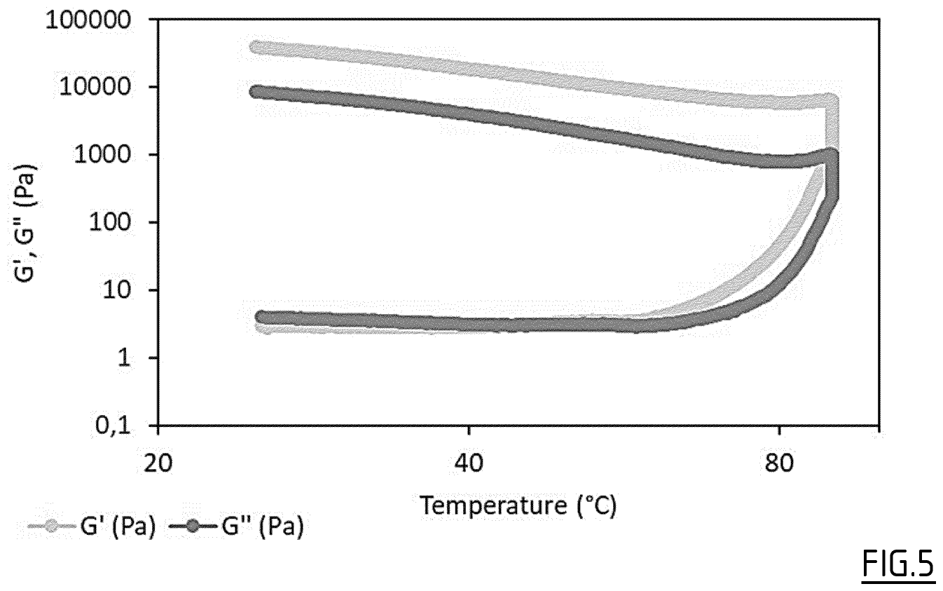

FIGS. 4 and 5 compare the gelling properties by thermal treatment of proteins obtained by both processes.

A solution, containing 10% of proteins obtained by the method of the invention can form a gel, contrary to standard pH-metric proteins. In this case, rheological properties are only explained by the solution viscosity.

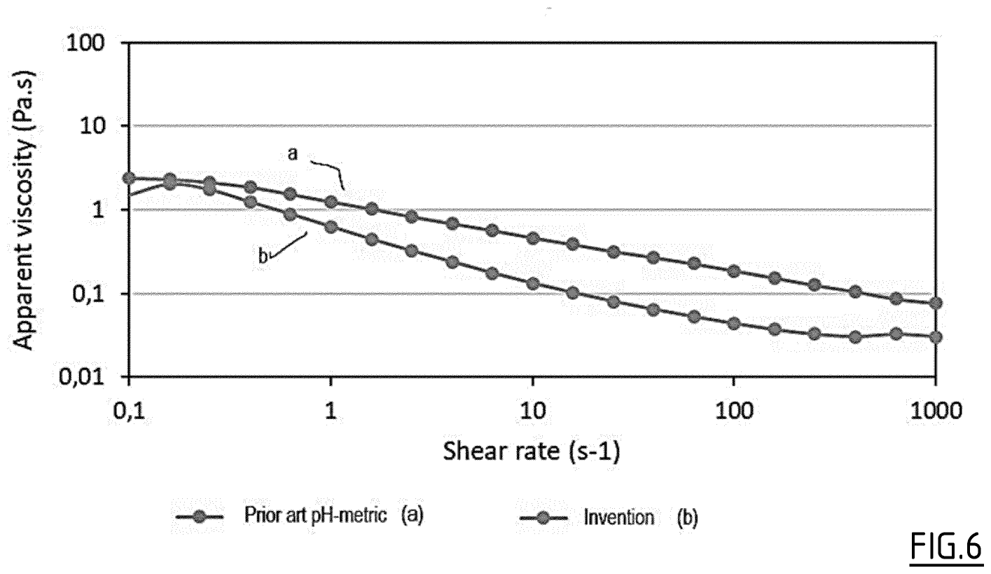

FIG. 6 shows the viscosity evolution of a 10 % dry solid solution, according to shear stress. The viscosity of proteins of the invention solution is lower than the precipitated one, regardless the shear stress.

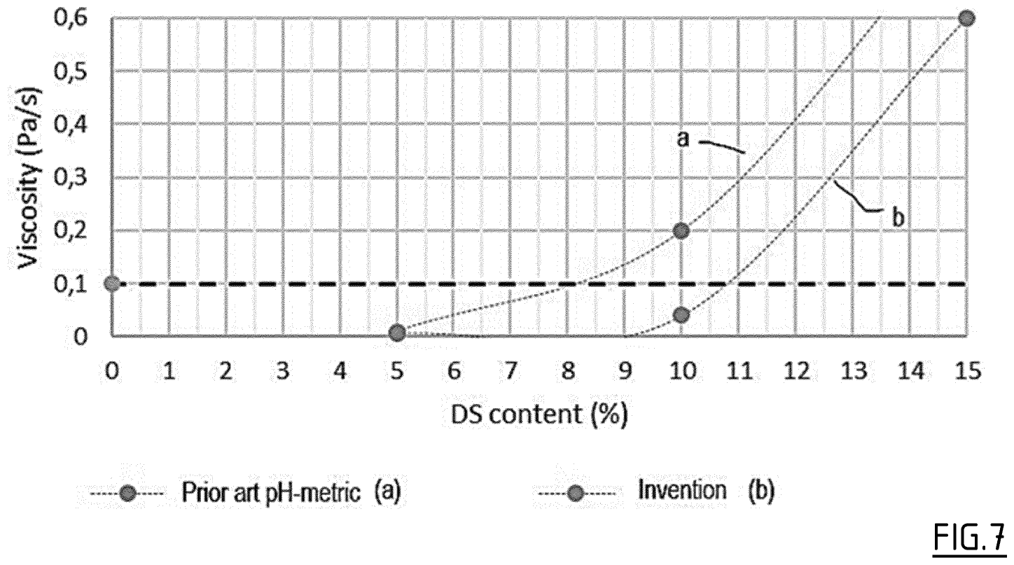

This viscosity was measured at different concentration for 100 s⁻¹ shear rate. Results are presented in Table 15 and FIG. 7. At an equivalent shear rate, the solution obtained by the method of the invention has a lower viscosity than the precipitated one, for any concentration.

TABLE 15
Viscosity evolution according to the DS content

| Product | Concentration | Viscosity at 100 s⁻¹ (Pa/s) |
|---|---|---|
| Standard pH metric process | 5% | 0.01 |
| Invention | 5% | 0.006 |
| Standard pH metric process | 10% | 0.2 |
| Invention | 10% | 0.04 |
| Standard pH metric process | 15% | 0.8 |
| Invention | 15% | 0.6 |

Conclusion

The pulses proteins functionality and taste are significantly improved by a process comprising acid wash followed by alkaline extraction as defined above.

These new functionalities can extend the proteins isolate application field and also reduce the production OPEX. For example, a lower viscosity allows a higher concentration before drying which can significantly decrease the energy consumption.

### Example 6: Other Protein Sources

The process developed above was applied on different proteins sources. Results are summarized in Table 16.

TABLE 16
Other plant sources results

| Plant source | Extraction yield | Purity |
|---|---|---|
| Red lentil | 53% | 88% |
| Mojette bean | 32% | 82% |
| Azuki bean | 60% | 84% |

### Example 7: Removal of Anti-Nutritional Factors: The α-Galactosides

The content of α-galactosides was measured in two samples of protein isolate of the invention (Batch 1 and Batch 2), in two commercial protein isolate samples (Commercial 1 and Commercial 2) and in a sample of protein isolate obtained by the standard pH-metric process.

TABLE 17
Alpha-galactosides content of samples

| | Batch | Batch | Commer- | Commer- | pH |
|---|---|---|---|---|---|
| Analysis | 1 | 2 | cial 1 | cial 2 | metric |
| Raffinose (g/100 g) | ND | ND | ND | 0.22 | 0.26 |
| Stachyose (g/100 g) | ND | ND | 0.17 | 0.91 | 0.9 |
| Verbascose (g/100 g) | ND | ND | 0.12 | 0.52 | 0.64 |
| Total alpha- | ND | ND | 0.29 | 1.65 | 1.80 |
| galactosides (g/100 g) | | | | | |

ND: not detected - detection threshold = 0.10%

As shown in Table 17, no alpha-galactoside was detected in the two samples Batch 1 and Batch 2 (the detection threshold of the measurement method being 0,1%). On the contray, the samples Commercial 1 and 2 contain respectively 0,3 and 1,7 g/100 g of alpha-galactosides and the sample of protein isolate obtained by the standard pH metric method is 1,80 g/100 g.
As a comparison, the average alpha-galactosides content is 5 g/100 g in pea flour and 10 g 15/100 g in pea concentrate (IMPROVE data).

1. A legume protein isolate from plant parts, wherein said protein isolate comprises at least 80% of proteins on dry matter and comprises less than 0,10% of alpha-galactosides by weight of the protein isolate.

2. The legume protein isolate according to claim 1, wherein said protein isolate has at least one feature selected from the group consisting of:
a less yellow color, by comparison to a protein isolate obtained by a method comprising a first step of alkaline extraction followed by a second step of acid precipitation,
an improved taste by comparison to a protein isolate obtained by a method comprising a first step of alkaline extraction followed by a second step of acid precipitation,
a neutral odor without beany smell,
a solubility higher than 50% at pH8 in a 2% protein solution,
an improved foaming capacity, by comparison to a protein isolate obtained by a method comprising a first step of alkaline extraction followed by a second step of acid precipitation,
a gelling property and
a low viscosity.

3. A composition comprising at least one legume protein isolate according to claim 1.

4. The composition according to claim 3, wherein said composition is a food composition, a feed composition, a pet-food composition, a cosmetic composition, a nutraceutical composition or a pharmaceutical composition.

5. A method for preparing a legume protein isolate from plant parts according to claim 1, said method comprising the following successive steps:
a) washing said plant parts in acidic conditions, thereby obtaining acid washed plant parts;
b) contacting said acid washed plant parts with an alkaline solution, and
c) recovering the liquid fraction, thereby obtaining a protein isolate displaying a purity higher than 80%,
wherein said method does not comprise any acidic precipitation step.

6. The method according to claim 5, wherein the pH of said washing step is of 3.5 to 5.

7. The method according to claim 5, wherein said acid washed plant parts are recovered at the end of said washing step by solid/liquid separation.

8. The method according to claim 5, wherein said acid washed plant parts have a pH comprised between 3.5 and 5.

9. The method according to claim 5, said method further comprising between the washing step a) and the contacting step b), a step of rinsing said acid washed plant parts with an aqueous solution.

10. The method according to claim 9, wherein said acid washed plant parts have a pH comprised between 3.5 and 5 after said rinsing step.

11. The method according to claim 5, wherein said alkaline solution used in step b) has a pH of 7 to 9.

12. The method according to claim 5, wherein said liquid fraction is recovered at step c) by solid/liquid separation.

13. The method according to claim 5, wherein said steps b) and c) are repeated at a higher pH.

14. The method according to claim 5, wherein said protein isolate is directly obtained at said recovering step c).

15. The method according to claim 5, further comprising after said recovering step c), a neutralization step, a heat treatment step, a concentration step and/or a drying step.

16. The method according to claim 5, wherein said plant parts are seeds.

17. The method according to claim 16, wherein said seeds are provided in the form of flour in said washing step a).

18. A method of improving digestive comfort, wherein said method comprises using a protein isolate according to claim 1 as a nutritional ingredient.
